(19) United States
(12) Patent Application Publication
(10) Pub. No.: US 2009/0259887 A1
(43) Pub. Date: Oct. 15, 2009

(54) SELF-SERVICE TERMINAL EQUIPMENT AND GUIDANCE SCREEN PROCESSING METHOD

(75) Inventor: Yoshiaki Takahira, Ishikawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: PFU LIMITED, Ishikawa (JP)

(21) Appl. No.: 12/248,912

(22) Filed: Oct. 10, 2008

(30) Foreign Application Priority Data
Apr. 11, 2008 (JP) 2008-103774

(51) Int. Cl. G06F 11/07

(52) U.S. Cl. 714/15; 714/E11.023

(57) ABSTRACT

A self-service terminal equipment includes at least one input/output device, a display device, a storage unit, and a control unit, wherein the storage unit includes a guidance information storage unit that stores recovery information in association with guidance information, the control unit includes a user program executing unit, and an input/output interface control unit, and the input/output interface control unit includes a command information control unit that outputs command information to the input/output device such that the input/output device is controlled, a recovery information control unit that inputs the recovery information output from the input/output device controlled, and a guidance screen control unit that obtains the guidance information stored in the guidance information storage unit corresponding to the recovery information input by control of the recovery information control unit and displays a guidance screen that displays the guidance information on the display device.

### BACKGROUND OF THE INVENTION

1. Field of the Invention

The present invention relates to a self-service terminal equipment, and guidance screen processing method.

2. Description of the Related Art

Recently, a self-service terminal equipment such as a kiosk terminal, which displays information on a liquid crystal display and is capable of being operated using a touch panel or the like, is placed on a street and in a store such as a convenience store. The self-service terminal equipment is used, for example, to offer services such as transportation and sightseeing guide at a station and an administrative institution, online sales of thickets, printing of pictures taken by a digital camera, and an ATM service of a bank. When handling various information media in a computer such as the self-service terminal equipment, it is required to connect various input/output devices accordingly, and it requires an interface that controls the input/output devices.

For example, JP-A-2004-30640 discloses a method in which a kiosk device connected to a network has a driver program (local API) or the like for each input/output device, and a file in a configuration set connected to the network includes a build-in control program, and the device controls a local API for the device on the kiosk using the control program.

JP-A-11-353406 discloses a self-service terminal equipment (such as ATM) connected to a network and including peripheral devices such as a card reader, a receipt printer, and a user interface in which each peripheral device has an independent control application, and it is configured that a certain peripheral device operates according to a signal generated by another peripheral device during use of the equipment.

JP-A-2002-288735 discloses that a multi-cache board that directly controls a peripheral device is provided so as to mediate between a driver software that controls the peripheral device by the instruction of an application software that controls the peripheral device and the peripheral device in order to prevent substantial change of the software from occurring according to a version up of the peripheral device or the like.

JP-A-10-260927 discloses that a disk drive emulator that provides a signal with which a general-purpose computer recognizes a peripheral device as a disk drive to the peripheral device connected to the general-purpose computer is set up so as to operate the peripheral device from a host computer without requiring a special device driver, thereby registering an API application with a memory of the peripheral device through the disk emulator.

JP-A-7-44290 discloses a control system having a controller connected to a plurality of objectified peripheral devices through a common communication line to integrally control the peripheral devices in which the controller is configured to enable the control of the peripheral devices on the controller side by reading a control information stored on the peripheral device side in a predetermined mode according to the connection with the peripheral devices, and to transmit the instruction given to the controller side to each peripheral device, in order to realize an environment capable of transparently using the multimedia devices from another controller without requiring a special software such as a device driver.

In the above-described computer system to which various input/output devices are connected, when an error occurs in the input/output device while offering information service to a third party (user) being the target to offer the service, it is required to inform the user of guidance information instructing to repeat an operation and urging to call a staff, and at the same time, informs a system manager of the occurrence of the error and the event and cause of the error, thereby urging recovery of the system.

However, in the conventional self-service terminal equipment or the like, generally, when the error occurs in the input/output device, the information (recovery information) informed by the input/output device is only about the event and cause of the error, and there is a problem that the guidance information such as “please call the staff”, “please go to the customer service desk”, and “please try once again” are not informed to the user.

Further, the mode (interface specification) of the recovery information informed by the input/output device substantially depends on the device due to the device characteristics and different manufacturer (maker) of the devices; therefore, when the error occurs in the input/output device, it is required to individually judge the information regarding the event and cause of the error informed by the input/output device for each input/output device in order to inform the user of the guidance information, and this causes various problems. That is to say, the conventional self-service terminal equipment or the like has the following three problems, for example.

### (1) Increase in Program Development Amount

In the conventional self-service terminal equipment or the like, when developing the user service program, there is a problem that the development amount of the portion regarding the error processing of the input/output device becomes enormous and complicated because it is required to generate the guidance information for each input/output device and each recovery information.

### (2) Deterioration of Serviceability Due to Dependency on Maker

In the conventional self-service terminal equipment or the like, in the user service program, the program of the interface for the input/output device substantially depends on the maker, which manufactures the input/output device, so that when the maker no more supplies the device for the reason such as discontinuation of manufacturing or the like and the device is changed to that of another maker, there is the problem that the program of the interface for the device has to be completely rewritten.

### (3) Deterioration of Changeability

In the conventional self-service terminal equipment or the like, when adding a new input/output device by adding an input media or the like, there is the problem that the change in program is not easy since the program is enormous and complicated.

The problem in the conventional self-service terminal equipment is specifically explained with reference to FIG. 1. FIG. 1 is a view for showing one example of the software configuration of the conventional self-service terminal equipment. As shown in FIG. 1, the conventional self-service terminal equipment is configured to execute the user program and the manager program together with the control program such as the operating system (OS) such as Windows (registered trademark). Therefore, when the input/output device is added or changed, it is required to change each user program such that the corresponding guidance information is output, so that increase in development amount due to creation according to characteristics of each input/output device, deterioration of serviceability due to the complicated program, and the quality deterioration due to the increased and complicated program are unavoidable as described above.

### SUMMARY OF THE INVENTION

It is an object of the present invention to at least partially solve the problems in the conventional technology.

A self-service terminal equipment according to one aspect of the present invention includes at least one input/output device, a display device, a storage unit, and a control unit, wherein the storage unit includes a guidance information storage unit that stores recovery information informed by the input/output device in association with guidance information to be informed to a user, the control unit includes a user program executing unit, and an input/output interface control unit that controls input and output of the input/output device, and the input/output interface control unit includes a command information control unit that outputs command information to the input/output device such that the input/output device is controlled based on an input/output instruction received from the user program executing unit, a recovery information control unit that inputs the recovery information output from the input/output device controlled based on the command information, and a guidance screen control unit that obtains the guidance information stored in the guidance information storage unit corresponding to the recovery information input by control of the recovery information control unit and displays a guidance screen that displays the guidance information on the display device.

A guidance screen control method according to another aspect of the present invention is executed by a self-service terminal equipment including at least one input/output device, a display device, a storage unit, and a control unit, wherein the storage unit includes a guidance information storage unit that stores recovery information informed by the input/output device in association with guidance information to be informed to a user, the control unit includes a user program executing unit, and an input/output interface control unit that controls input and output of the input/output device, and the method includes a command information control step of outputting command information to the input/output device such that the input/output device is controlled based on an input/output instruction received from the user program executing unit, a recovery information control step of inputting the recovery information output from the input/output device controlled based on the command information, and a guidance screen control step of obtaining the guidance information stored in the guidance information storage unit corresponding to the recovery information input by control of the recovery information control unit and displays a guidance screen that displays the guidance information on the display device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view showing one example of software configuration in a conventional self-service terminal equipment;

FIG. 2 is a block diagram showing a configuration of a self-service terminal equipment of the present invention;

FIG. 3 is a flowchart indicating the basic principle of the present invention;

FIG. 4 is a block diagram showing one example of a configuration of the self-service terminal equipment to which the present invention is applied;

FIG. 5 is a view showing one example of file configuration of a guidance information file;

FIG. 6 is a view showing one example of file configuration of a master information file;

FIG. 7 is a view showing one example of a guidance master that manages a guidance pattern code stored in the master information file;

FIG. 8 is a view showing one example of a guidance message master that manages a guidance message corresponding to a guidance message code stored in the master information file;

FIG. 9 is a view showing one example of an input/output device control master stored in the master information file;

FIG. 10 is a conceptual diagram showing one example of processing of guidance control of the self-service terminal equipment according to the embodiment; and

FIG. 11 is a flow flowchart showing one example of details of processing of the guidance control of the self-service terminal equipment according to the embodiment.

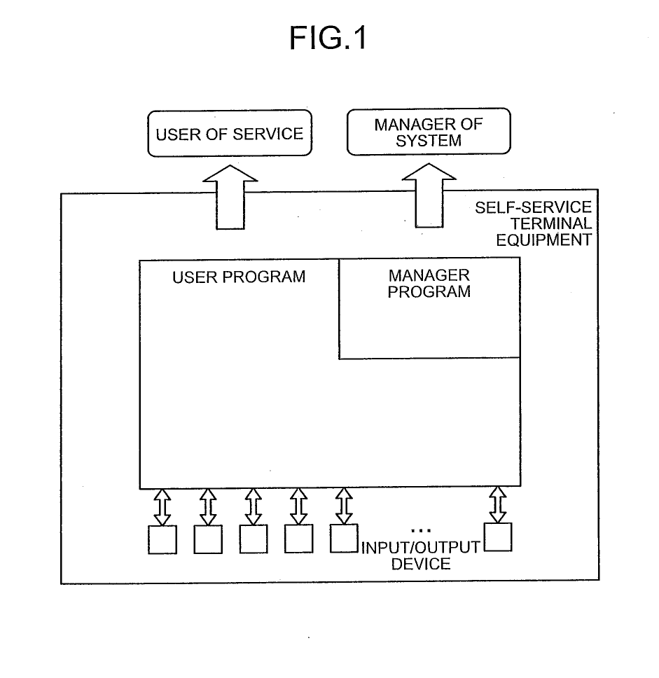

### DETAILED DESCRIPTION OF THE PREFERRED EMBODIMENTS

The following describes an embodiment of a self-service terminal equipment such as a kiosk terminal for such a device according to the present invention in detail with reference to the drawings. The embodiment is illustrative only, and is not intended to limit the present invention in any way.

### Overview of the Invention

The following outlines the present invention, and then, a configuration and processing of the present invention are explained in detail.

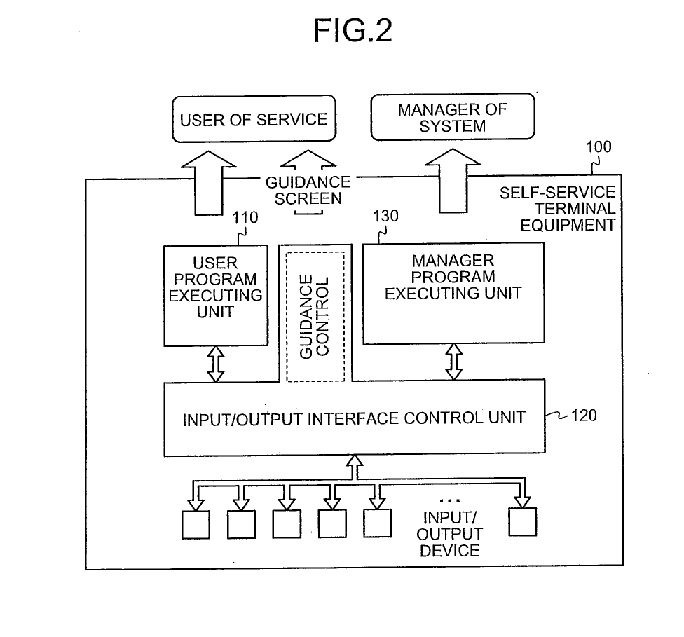

As shown in FIG. 2, a self-service terminal equipment 100 of the present invention conceptually has at least one input/output device, a user program executing unit 110 that executes various processes to be offered to a user of the self-service terminal equipment 100, a manager program executing unit 130 that executes various processes to be offered to a manager of the self-service terminal equipment 100, and an input/output interface control unit 120 that controls input and output of the input/output device.

The input/output interface control unit 120 of the self-service terminal equipment 100 of the present invention integrates the input/output devices to provide a standard interface for the input/output device, and when the input/output device informs recovery information such as an error, the input/output interface control unit 120 determines a coping strategy based on information regarding event and cause of the error to control a system. Thereby, when developing the user program, it is not necessary to be conscious of characteristics inherent to the input/output device and to determine contents of the information regarding event and cause of the error for each input/output device, so that it is possible to substantially reduce a development amount thereof. The user program executing unit 110 does not directly control the input/output device, so that it is possible to change the input/output device without changing the user program. It is possible to configure the manager program executing unit 130 to easily perform registration and inquiry or change of guidance information.

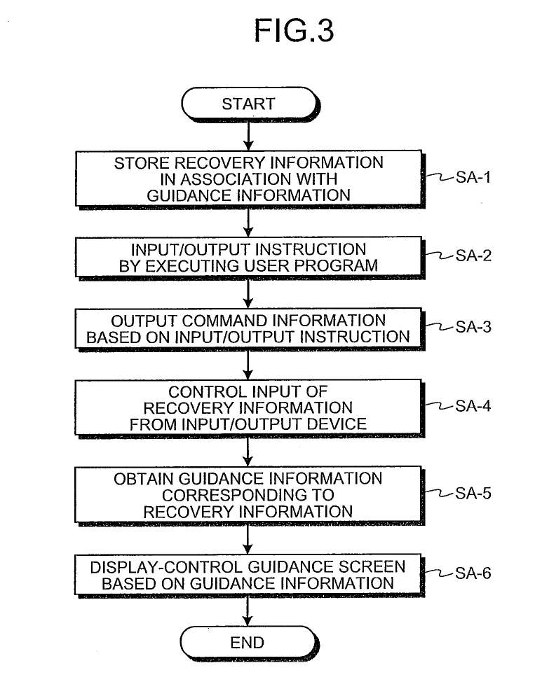

The self-service terminal equipment 100 of the present invention has at least one input/output device, a display device, a storage unit, and a control unit. As shown in FIG. 3, in the storage unit, the recovery information informed by the input/output device and the guidance information to be informed to the user (such as audio, text, or image data, for example, “please call the staff”, “please go to the customer service desk”, and “please try once again”) are associated with each other and stored (step SA-1).

In the self-service terminal equipment 100, when there is an input/output instruction from the user program executing unit 110 (step SA-2), the input/output interface control unit 120 outputs command information to the input/output device such that the input/output device is controlled based on the received input instruction (step SA-3).

The input/output interface control unit 120 of the self-service terminal equipment 100 controls to input the recovery information (for example an error code) output from the input/output device controlled based on the command information (step SA-4).

The input/output interface control unit 120 of the self-service terminal equipment 100 obtains the guidance information stored in the storage unit, which corresponds to the input recovery information (step SA-5).

The input/output interface control unit 120 of the self-service terminal equipment 100 displays a guidance screen that displays the guidance information on the display device (step SA-6). The input/output interface control unit 120 may control to display the guidance screen on an entire display screen of the display device.

The self-service terminal equipment 100 may store master information in which the guidance information is stored by being associated with a guidance pattern code in the storage unit, and the input/output interface control unit 120 may control the guidance pattern code corresponding to the recovery information to be set by the manager through the input/output device, and registers the guidance information stored in the storage unit corresponding to the set guidance pattern code in association with the recovery information.

### Configuration of the Self-Service Terminal Equipment 100

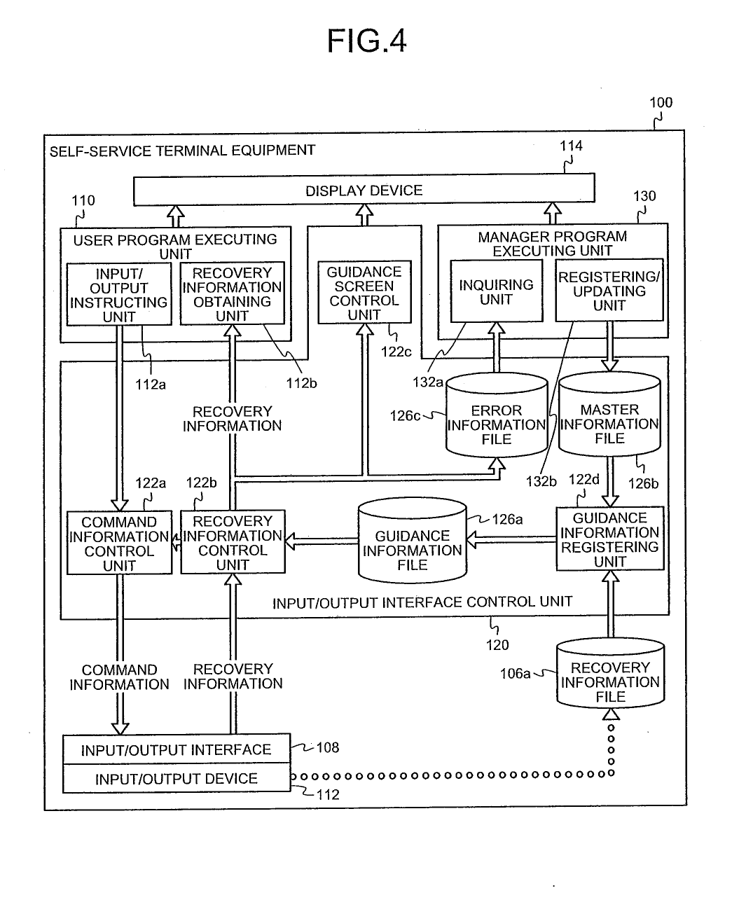

The following first describes a configuration of a self-service terminal equipment 100 with reference to FIGS. 4 to 9. FIG. 4 conceptually shows only parts related to the present invention.

In FIG. 4, in general, the self-service terminal equipment 100 is provided with at least one input/output device 112, a display device 114, a storage unit (shown in FIG. 4 as cylinders, the storage unit includes a recovery information file 106a, a guidance information file 126a, a master information file 126b, and an error information file 126c), and a control unit (the control unit includes a user program executing unit 110, an input/output interface control unit 120, and a manager program executing unit 130). The control unit such as a CPU integrally controls an entire self-service terminal equipment 100. The storage unit stores various databases and tables. The input/output interface 108 connects to an input/output device 112. The input/output device 112 is each input/output device connected through the input/output interface 108. The display device 114 displays guidance information or the like and a monitor or an audio output device such as a speaker may be used as the device. The units composing the self-service terminal equipment 100 are communicably connected through an optional communication channel.

The various databases and tables (the recovery information file 106a, the guidance information file 126a, the master information file 126b, and the error information file 126c) stored in the storage unit of the self-service terminal equipment 100 are the storage units such as a fixed disk drive. For example, the storage unit of the self-service terminal equipment 100 stores various programs used in various processing, tables, image files, databases, folders or the like.

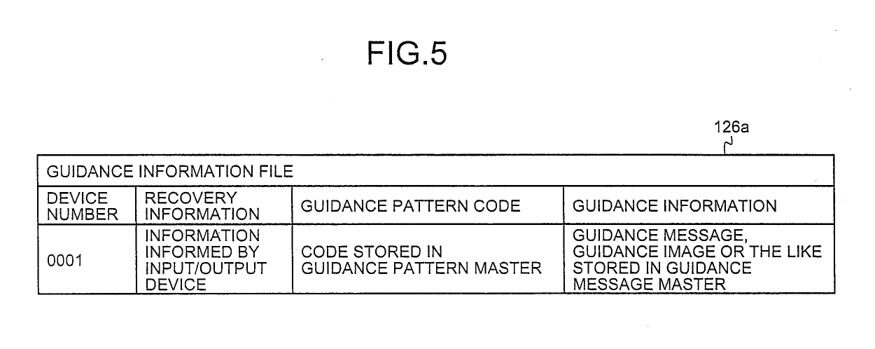

Out of each component of the storage unit, the guidance information file 126a stores the recovery information informed by the input/output device 112 and the guidance information to be informed to the user and the manager in association with each other. In this embodiment, as shown in FIG. 5, the guidance information file 126a stores a device number of the input/output device 112, the recovery information such as the error code informed by the input/output device 112, the guidance pattern code (such as numbers and signs for classifying the recovery information into some guidance patterns) for uniquely identifying a pattern of guidance, and the guidance information (including image information or the like such as guidance message information and a guidance screen) in association with each other.

Referring again to FIG. 4, the master information file 126b stores various pieces of master information (including, for example, guidance information associated with the guidance pattern code) used in the self-service terminal equipment 100.

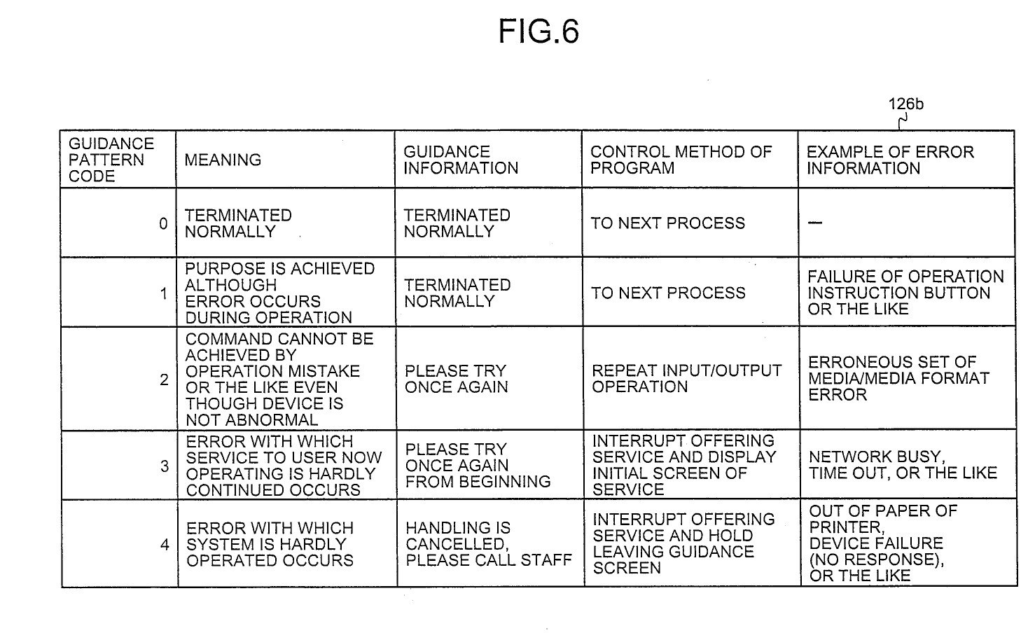

In one example shown in FIG. 6, the recovery information is classified into five guidance patterns 0 to 4, and each guidance pattern code is associated with the guidance information to be informed to the user or the like, a program control method, the error information, or the like.

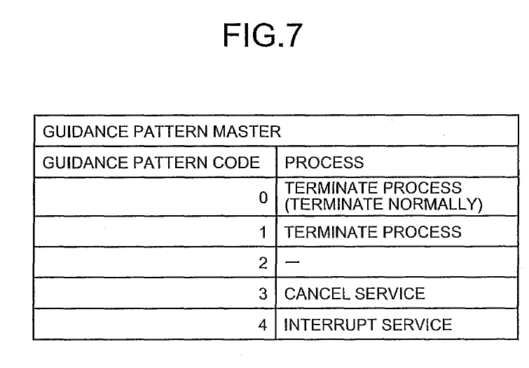

As shown in FIG. 7, a guidance pattern master stores the guidance pattern code and process or the like controlled by the program in association with each other.

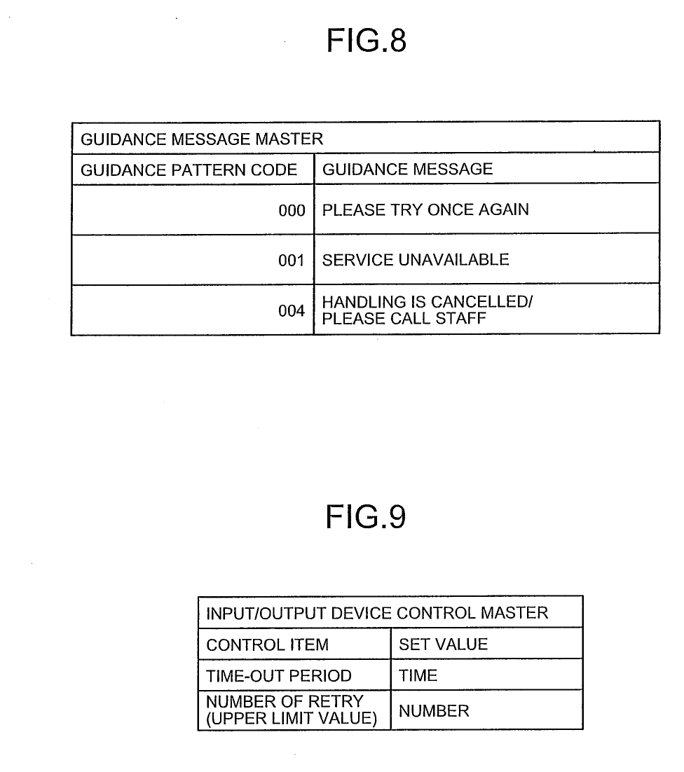

As shown in FIG. 8, the guidance message master stores the guidance message code and the guidance message in association with each other.

As shown in FIG. 9, the input/output device control master stores control items (for example, a time-out period, the number of retry or the like) for controlling the input/output device 112 and a set value or the like in association with each other.

The error information file 126c stores the error information corresponding to the recovery information output from the input/output device 112 by the command information instructed by the user program executing unit 110, and is used when outputting the error information to the manager program executing unit 130 by the inquiry by an inquiring unit 132a of the manager program executing unit 130.

The recovery information file 106a stores the recovery information output from the input/output device 112 by the command information instructed by the user program executing unit 110, and is used when outputting the recovery information to the guidance information registering unit 122d.

In FIG. 4, the control unit is functionally conceptually provided with the user program executing unit 110, the input/output interface control unit 120, the manager program executing unit 130, and the like, and includes an internal memory for storing a control program such as an Operating System (OS), a program that defines various procedures, and required data. The control unit performs information processing for executing various processes using such programs.

The user program executing unit 110 executes the user program. The user program executing unit 110 is provided with an input/output instructing unit 112a and a recovery information obtaining unit 112b, as shown in FIG. 4. The input/output instructing unit 112a has a function to instruct the input/output device 112 to input and output in the user program. The recovery information obtaining unit 112b has the function to obtain the recovery information from the input/output device 112 in the user program.

The manager program executing unit 130 executes the manager program. The manager program executing unit 130 is provided with an inquiring unit 132a and a registering/updating unit 132b, as shown in FIG. 4. The inquiring unit 132a has the function to inquire about the error information corresponding to the recovery information from the input/output device 112 by referring to the error information file 126c, in the manager program. The registering/updating unit 132b has the function to register or update the contents of the master information file 126b in the manager program.

The input/output interface control unit 120 has the function to provide the standard interface for the input/output device 112 by integrating the input/output device 112 and to determine the coping strategy based on the information regarding the event and cause of the error to control the system when the recovery information such as the error is informed by the input/output device 112, and is provided with a command information control unit 122a, a recovery information control unit 122b, a guidance screen control unit 122c, and a guidance information registering unit 122d.

The command information control unit 122a outputs the command information to the input/output device 112 such that the input/output device 112 is controlled based on the input/output instruction received from the input/output instructing unit 112a of the user program executing unit 110.

The recovery information control unit 122b inputs the recovery information output from the input/output device 112 controlled based on the command information, returns the recovery information to the user program executing unit 110, and stores the same in the error information file 126c.

The guidance screen control unit 122c obtains the guidance information stored in the guidance information file 126a corresponding to the recovery information input by the control of the recovery information control unit 122b, and displays the guidance screen that displays the guidance information on the display device 114.

The guidance information registering unit 122d controls the guidance pattern code corresponding to the recovery information to be set by the manager through the input/output device 112, and registers the guidance information stored in the master information file 126b corresponding to the set guidance pattern code in the guidance information file 126a in association with the recovery information.

### Processing of the System

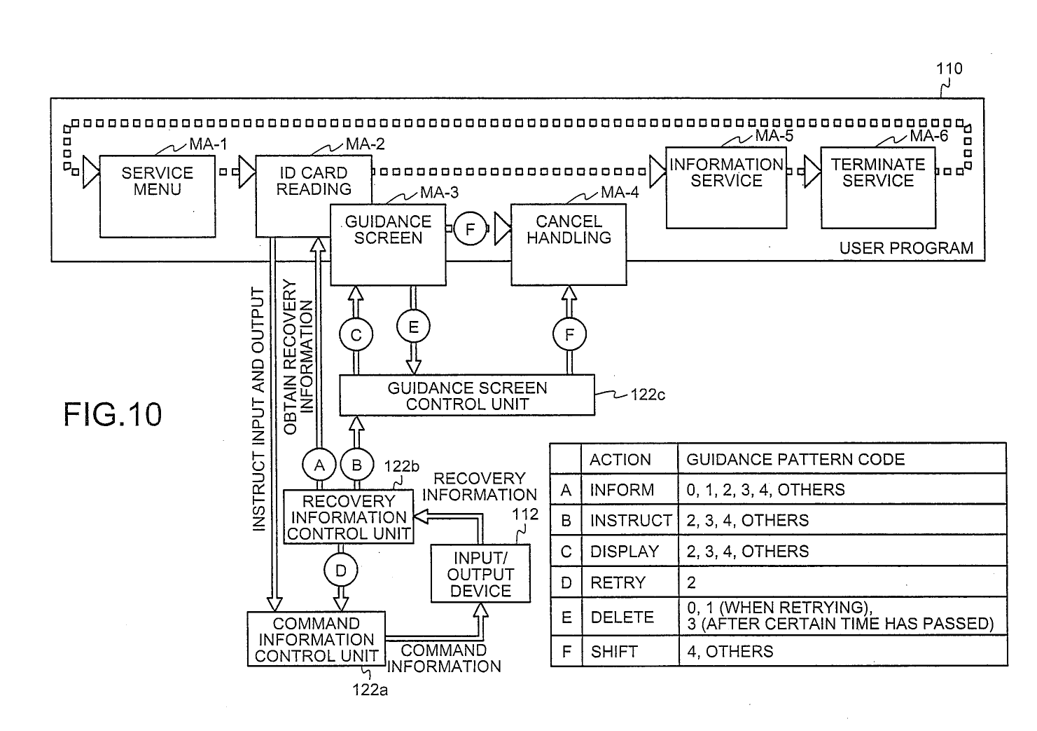

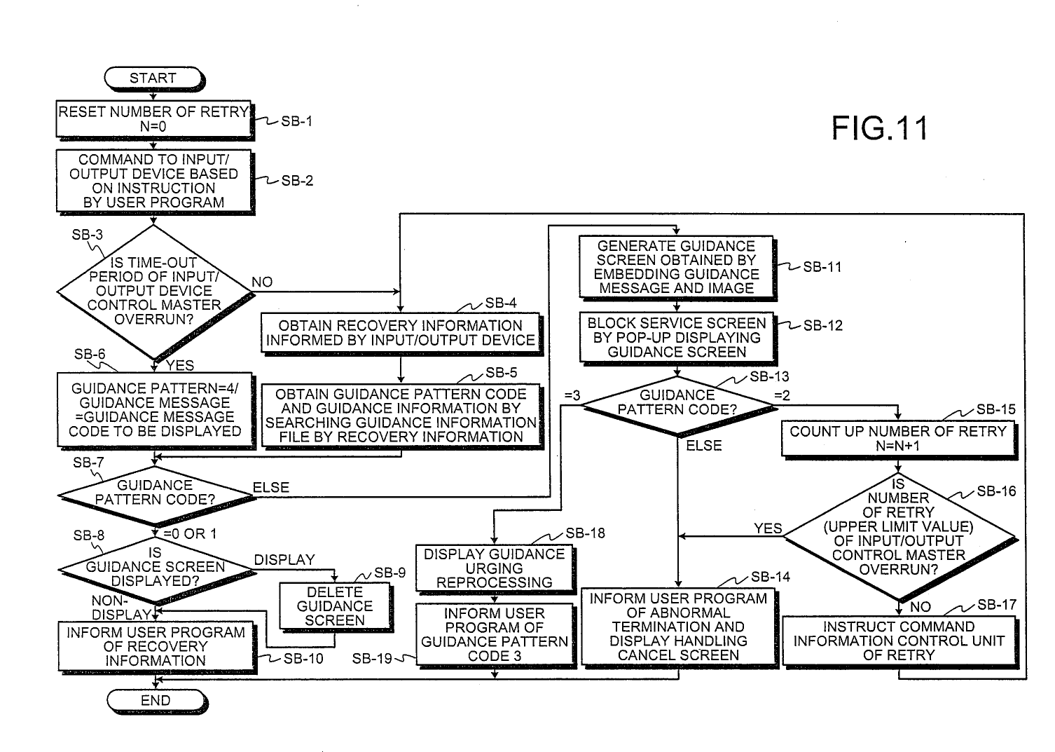

The following describes in detail one example of processing of the self-service terminal equipment 100 according to the present embodiment as configured above with reference to FIGS. 10 and 11.

### Processing of the Guidance Control

The following describes a concept of processing of the guidance control according to the self-service terminal equipment 100 with reference to FIG. 10.

The user program executing unit 110 displays a service menu screen on the display device 114 (MA-1). When the user selects a desired service, the user program executing unit 110 displays a screen indicating, for example, ID card reading on the display device 114 (MA-2).

The command information control unit 122a outputs the command information to the input/output device 112 such that the input/output device 112 is controlled based on the input/output instruction received from the input/output instructing unit 112a of the user program executing unit 110.

The recovery information control unit 122b inputs the recovery information output from the input/output device 112 controlled based on the command information, and obtains the guidance pattern code corresponding to the recovery information by referring to the guidance information file 126a.

The recovery information control unit 122b informs the user program executing unit 110 of the recovery information, in a case of A in FIG. 10 (that is to say, when the guidance pattern code is 0, 1, 2, 3, 4, or others).

The recovery information control unit 122b instructs the guidance screen control unit 122c to display a predetermined guidance screen, in a case of B in FIG. 10 (that is to say, when the guidance pattern code is 2, 3, 4, or others), and the guidance screen control unit 122c displays the predetermined guidance screen (MA-3), in a case of C in FIG. 10 (that is to say, when the guidance pattern code is 2, 3, 4, or others).

The recovery information control unit 122b controls the command information control unit 122a to retry outputting the command information to the input/output device 112, in a case of D in FIG. 10 (that is to say, when the guidance pattern code is 2).

The guidance screen control unit 122c deletes a guidance screen (MA-3) displayed on the display device 114, in a case of E in FIG. 10 (that is to say, when the guidance pattern code is 0, 1 at the time of retry or when the guidance pattern code is 3 after a certain period of time).

The guidance screen control unit 122c shifts the guidance screen (MA-3) to a handling cancel screen (MA-4), in a case of F in FIG. 10 (that is to say, when the guidance pattern code is 4 or others). The guidance screen control unit 122c may control the handling cancel screen (MA-4) to be displayed on the entire display screen of the display device 114. Further, the user program executing unit 110 may shift the screen indicating ID card reading (MA-2) to an information service screen (MA-5) and to a service termination screen (MA-6) by the recovery information obtained in a case of A in FIG. 10.

The following describes details of processing of the guidance control according to the self-service terminal equipment 100 with reference to FIG. 11.

First, the control unit of the self-service terminal equipment 100 resets number of retry (N) to 0 (step SB-1).

The command information control unit 122a outputs the command information to the input/output device 112 such that the input/output device 112 is controlled based on the input/output instruction received from the input/output instructing unit 112a of the user program executing unit 110 (step SB-2).

The recovery information control unit 122b determines whether a time-out period of the input/output device control master stored in the master information file 126b is overrun (step SB-3), and if it is not, obtains the recovery information output from the input/output device controlled based on the command information (step SB-4) and obtains the guidance pattern code and the guidance information corresponding to the recovery information by referring to the guidance information file 126a (steps SB-5).

On the other hand, when the time-out period is overrun at the step SB-3, the recovery information control unit 122b sets the guidance pattern code to 4, and further sets the guidance message of a predetermined time-out display screen (steps SB-6).

The guidance screen control unit 122c judges the guidance pattern code (step SB-7), and when the guidance pattern code is 0 or 1, judges whether the guidance screen is already displayed on the display device 114 (step SB-8), and when the guidance screen is displayed, deletes the guidance screen being displayed (step SB-9).

The recovery information control unit 122b informs the user program executing unit 110 of the recovery information (step SB-10).

On the other hand, the guidance screen control unit 122c generates the guidance screen obtained by embedding a predetermined guidance message and image (step SB-11) when the guidance pattern code is other than 0 and 1 at the step SB-7, and blocks the service screen or the like displayed by the user program executing unit 110 by pop-up displaying the guidance screen on the entire screen of the display device 114 (step SB-12).

The recovery information control unit 122b judges the guidance pattern code (step SB-13), and when the guidance pattern code is other than 2 and 3, informs the user program executing unit 110 of an abnormal termination and the guidance screen control unit 122c displays the handling cancel screen (step SB-14).

On the other hand, the recovery information control unit 122b counts up the number of retry (N) (step SB-15) when the guidance pattern code is 2 at the step SB-13, judges whether the number of retry (upper limit value) of the input/output control master stored in the master information file 126b is overrun (step SB-16), and when this is overrun, shifts the control to the step SB-14.

On the other hand, the recovery information control unit 122b instructs the command information control unit 122a to retry (step SB-17) when the number of retry (upper limit value) is not overrun at the step SB-16, and shifts the control to the step SB-4.

On the other hand, the recovery information control unit 122b allows the guidance screen control unit 122c to display the guidance screen to urge reprocessing (step SB-18) when the guidance pattern code is 3 at the step SB-13, and informs the user program executing unit 110 of the guidance pattern code 3 (step SB-19).

### Other Embodiments

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

For example, in the embodiment, the self-service terminal equipment 100 performs various processes as a stand-alone device. However, the self-service terminal equipment 100 can be configured to perform processes in response to request from a client terminal, which is a separate unit, and return the process results to the client terminal.

All the automatic processes explained in the present embodiment can be, entirely or partially, carried out manually. Similarly, all the manual processes explained in the present embodiment can be, entirely or partially, carried out automatically by a known method.

The process procedures, the control procedures, specific names, information including registration data for each process and various parameters such as search conditions, display example, and database construction, mentioned in the description and drawings can be changed as required unless otherwise specified.

The constituent elements of the self-service terminal equipment 100 are merely conceptual and may not necessarily physically resemble the structures shown in the drawings. For instance, the apparatus need not necessarily have the structure that is illustrated.

For example, the process functions performed by each device of the self-service terminal equipment 100, especially the each process function performed by the control unit, can be entirely or partially realized by a central processing unit (CPU) and a computer program executed by the CPU or by a hardware using wired logic. The computer program, recorded on a recording medium to be described later, can be mechanically read by the self-service terminal equipment 100 as the situation demands. In other words, the storage unit such as read-only memory (ROM) or hard disk (HD) stores the computer program that can work in coordination with the operating system (OS) to issue commands to the CPU and cause the CPU to perform various processes. The computer program is first loaded to the random access memory (RAM), and forms a control unit in collaboration with the CPU.

Alternatively, the computer program can be stored in any application program server connected to the self-service terminal equipment 100 via the network, and can be fully or partially loaded as the situation demands.

The computer-readable recording medium on which the computer program can be stored may be a portable type such as flexible disk, magneto optic (MO) disk, ROM, erasable programmable ROM (EPROM), electrically erasable programmable ROM (EEPROM), compact disk-read-only memory (CD-ROM), digital versatile disk (DVD), or a communication medium that stores the computer program for a short term such as communication channels or carrier waves that transmit the computer program over networks such as local area network (LAN), wide area network (WAN), and the Internet.

Computer program refers to a data processing method written in any computer language and written method, and can have software codes and binary codes in any format. The computer program can be a dispersed form in the form of a plurality of modules or libraries, or can perform various functions in collaboration with a different program such as the OS. Any known configuration in the each device according to the embodiment can be used for reading the recording medium. Similarly, any known process procedure for reading or installing the computer program can be used.

The storage unit is a fixed disk device such as RAM, ROM, and hard disk or flexible disk, optical disk, and stores therein various programs, tables, databases (such as the recovery information file 106a, the guidance information file 126a, the master information file 126b, and the error information file 126c), and files required for various processes.

The self-service terminal equipment 100 can also be connected to any existing personal computer, workstation, etc. and can be operated by executing software (that includes computer program, data, etc.) that implements the method according to the present invention in the personal computer or workstation.

The distribution and integration of the device are not limited to those illustrated in the figures. The device as a whole or in parts can be functionally or physically distributed or integrated in an arbitrary unit according to various attachments or how the device is to be used.

According to the present invention, it is not necessary to configure the user program so as to inform the user of the guidance information when the error or the like occurs in the input/output device 112, so that the increase in the program development amount and deterioration of the serviceability and changeability may be prevented.

According to the present invention, it is possible to block the operation screen displayed just before by the user program. This allows to perform the appropriate screen control such as the service interruption after the error by the processing on the input/output interface control unit 120 side, even when the user program freezes due to the error, for example, without depending on the error processing of the user program.

According to the present invention, it is possible that the manager easily registers the appropriate guidance information by the processing of the manager program or the like, so that it becomes possible to inquire and change the registered guidance information. Further, it becomes possible to control the display of the appropriate guidance information from the manager program side, so that it becomes possible to reduce the program development amount, simplify the serviceability, and enable the flexible change, without requiring to change the user program according to the input/output device 112 and the error code thereof or the like.

According to the present invention, it is possible to prevent the program development amount from increasing and the serviceability and changeability from decreasing, while configuring to inform the user of the appropriate guidance information when the error or the like occurs in the input/output device 112.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A self-service terminal equipment comprising at least one input/output device, a display device, a storage unit, and a control unit, wherein
the storage unit includes a guidance information storage unit that stores recovery information informed by the input/output device in association with guidance information to be informed to a user,
the control unit includes a user program executing unit, and an input/output interface control unit that controls input and output of the input/output device, and
the input/output interface control unit includes
a command information control unit that outputs command information to the input/output device such that the input/output device is controlled based on an input/output instruction received from the user program executing unit;
a recovery information control unit that inputs the recovery information output from the input/output device controlled based on the command information; and
a guidance screen control unit that obtains the guidance information stored in the guidance information storage unit corresponding to the recovery information input by control of the recovery information control unit and displays a guidance screen that displays the guidance information on the display device.

2. The self-service terminal equipment according to claim 1, wherein
the guidance screen control unit controls the guidance screen to be displayed on an entire display screen of the display device.

3. The self-service terminal equipment according to claim 1, wherein
the storage unit further includes a master information storage unit that stores master information storing the guidance information in association with a guidance pattern code, and
the input/output interface control unit further includes a guidance information registering unit that controls the guidance pattern code corresponding to the recovery information to be set by a manager through the input/output device and registers the guidance information stored in the master information storage unit corresponding to the set guidance pattern code in the guidance information storage unit in association with the recovery information.

4. A guidance screen control method executed by a self-service terminal equipment including at least one input/output device, a display device, a storage unit, and a control unit, wherein
the storage unit includes a guidance information storage unit that stores recovery information informed by the input/output device in association with guidance information to be informed to a user,
the control unit includes a user program executing unit, and an input/output interface control unit that controls input and output of the input/output device,
the method comprising:
a command information control step of outputting command information to the input/output device such that the input/output device is controlled based on an input/output instruction received from the user program executing unit;
a recovery information control step of inputting the recovery information output from the input/output device controlled based on the command information; and
a guidance screen control step of obtaining the guidance information stored in the guidance information storage unit corresponding to the recovery information input by control of the recovery information control unit and displays a guidance screen that displays the guidance information on the display device.

5. The guidance screen control method according to claim 4, wherein
the guidance screen control step of controlling the guidance screen to be displayed on an entire display screen of the display device.

6. The guidance screen control method according to claim 4, wherein
the storage unit further includes a master information storage unit that stores master information storing the guidance information in association with a guidance pattern code, and
the input/output interface control step further includes a guidance information registering step of controlling the guidance pattern code corresponding to the recovery information to be set by a manager through the input/output device and registers the guidance information stored in the master information storage unit corresponding to the set guidance pattern code in the guidance information storage unit in association with the recovery information.
